(19) United States
(12) Patent Application Publication
(10) Pub. No.: US 2012/0243812 A1
(43) Pub. Date: Sep. 27, 2012

(54) FLUID DYNAMIC BEARING

(76) Inventor: John Wun-Chang Shih, Hsinchu (TW)

(21) Appl. No.: 13/071,535

(22) Filed: Mar. 25, 2011

(51) Int. Cl. F16C 32/06

(52) U.S. Cl. 384/100

(57) ABSTRACT

A fluid dynamic bearing includes a body; an inner surface of the body being formed with a plurality of sawteeth trenches; each bending angle of each tooth of the sawteeth trench being selected from one of two difference values. Each sawteeth trench has eight teeth, four at the right side and four at the left side. Eight bending angles of eight teeth of one trench are selected from two kinds of different angles which are alternatively arranged. The bearing is suitable for spindles of various rotation speeds so as to generate fluid dynamic pressure and the bearing is also suitable for various rotation speeds of spindles.

### FIELD OF THE INVENTION

The present invention relates to bearings, in particular to a fluid dynamic bearing; wherein an inner surface of the body being formed with a plurality of sawteeth trenches; each bending angle of each tooth of the sawteeth trench being selected from one of two difference values.

### BACKGROUND OF THE INVENTION

In general, the motor of a hard disk is supported by a ball bearing. As the motor rotates, the balls of the ball bearing will rotate therewith.

The fluid dynamic bearing (FDB) is coated with a layer of oil film for replacing the balls used in the prior art bearing. The advantage of the FDB is that the metal contact surface is reduced as the motor rotates so that the wearing to the metal is also reduced. The FDB can absorb the external vibration effectively to protect the surface of the bearing so that the friction is decreased and thus noises, heat and wearing are also reduced. These are helpful to the use and efficiency of the hard disk drive. When the FDB rotates, the lubricated oil will flow down along trenches. Oil in the upper and lower trenches flow to the tip portions thereof so that the spindle of the motor suffers from a pressure of the bearing. The lubricated oil will push the spindle away from the surface of the bearing so that the spindle will not contact the bearing. The angle of the tip ends of the trench of the bearing and the rotation of the spindle will affect the pressure between the bearing and the spindle so as to affect the effect of the lubrication.

The FDB are widely used in the motors of hard disks, motors of the HDs, DVDs and the motors of small fans. However, since current trenches for the FDBs have only one bending angle, the rotation of the spindle of the motor is limited by this design.

### SUMMARY OF THE INVENTION

The object of the present invention is to provide a fluid dynamic bearing, in that the present invention is suitable for spindles of motors to rotate in various speeds so as to generate suitable fluid dynamic pressure.

To achieve above object, the present invention provides a fluid dynamic bearing, comprising: a body; an inner surface of the body being formed with a plurality of sawteeth trenches; each bending angle of each tooth of the sawteeth trench being selected from one of two difference values. Each sawteeth trench has eight teeth, four at the right side and four at the left side; and eight bending angles of eight teeth of one trench are selected from two kinds of different angles which are alternatively arranged.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a front view of the present invention.

FIG. 3 is a left side view of the present invention.

FIG. 4 is an elevational view of the present invention.

FIG. 5 is a bottom view of the present invention.

FIG. 6 is a schematic view showing the expansion of the trenches of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

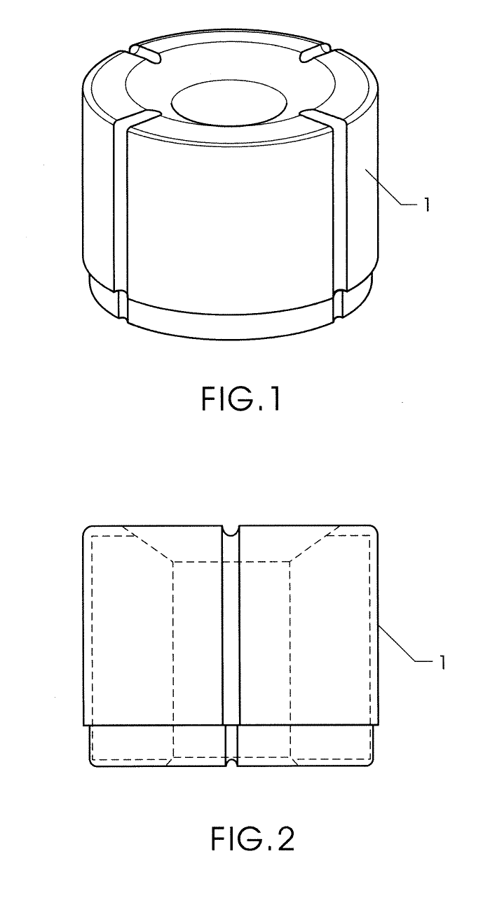

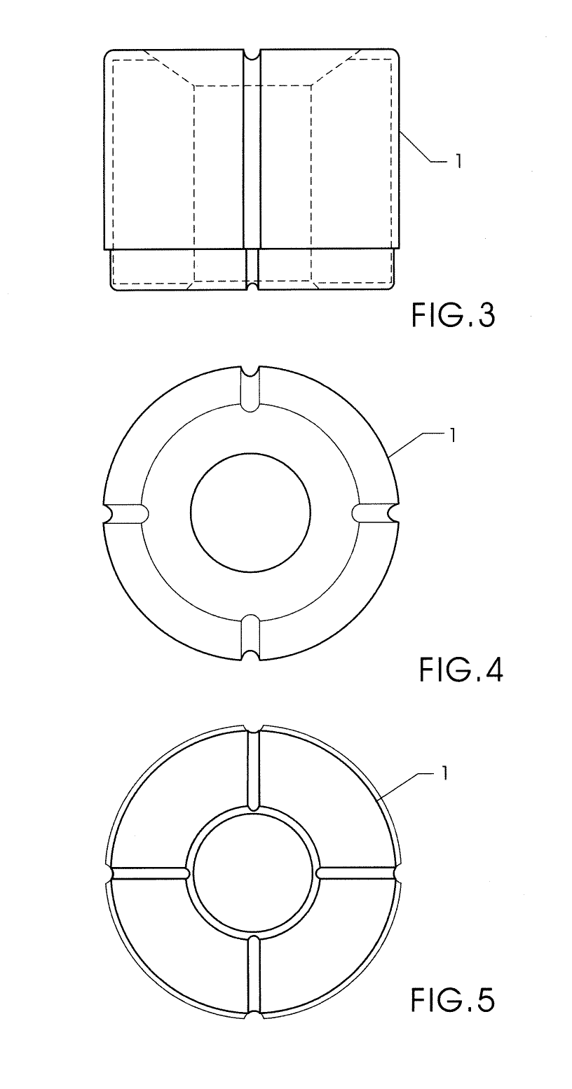

Referring to FIGS. 1 to 4, the structure of the present invention is illustrated.

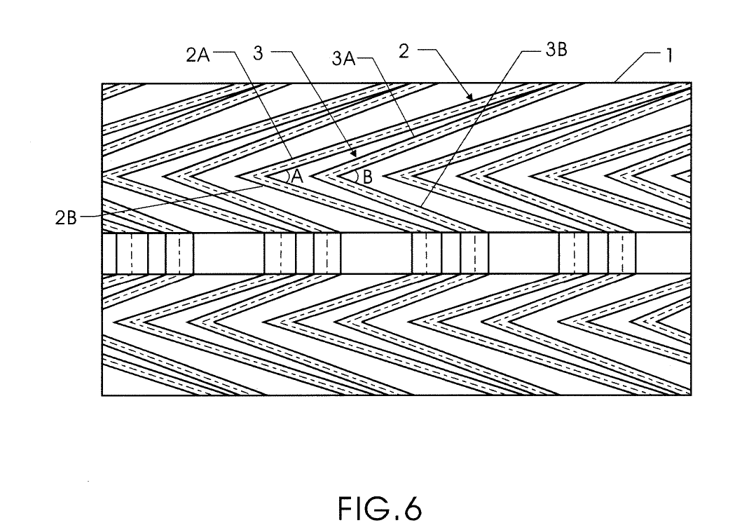

In FIG. 6, the fluid dynamic bearing of the present invention is illustrated. The bearing includes a body 1. An inner surface of the body 1 is formed with a plurality of sawteeth trenches 2, 3. Each sawteeth trench 2, 3 is formed with eight teeth, four at the right side and four at the left side. However, the number of teeth in each trench does not confine to eight. Other number is permissible. Two adjacent trenches 2, 3 are formed as as a pair. The bending angle of each tooth of the sawteeth trench 2, 3 may be selected from two difference values which are angle A and angle B. Eight bending angles of one trench 2, 3 include 4 angle As and 4 angle Bs which are alternatively arranged.

When a spindle of the motor supported by the bearing of the present invention, lubricated oil will flow along the trenches 2, 3 and flows towards the bending angles from the upper trenches 2A, 3A and lower trenches 2B, 3B so that a pressure is induced between the spindle and the bearing. As a result, the oil will push the bearing away from the surface of the spindle. The spindle will not directly contact the bearing. Since in the present invention, there are two different kinds of bending angles A and B, the coverage of the rotation speed of the spindle is widened. In the following, the effect of the present invention will be described with reference to a fan using the bearing of the present invention.

Firstly, when the bearing of the present invention is applied to a DC fan, the bending angles for the trenches in the bearing are suitable for the fan without needing to make another ones.

Secondly, the present invention is especially suitable for a speed variable DC fan.

Therefore, the present invention is suitable for spindles of various rotation speeds so as to generate fluid dynamic pressure. Meanwhile the present invention is suitable for various rotation speeds of spindles.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A fluid dynamic bearing, comprising:
a body;
an inner surface of the body being formed with a plurality of sawteeth trenches; each bending angle of each tooth of the sawteeth trench being selected from two difference values.

2. The fluid dynamic bearing as claimed in claim 1, wherein each sawteeth trench includes eight teeth, four at the right side and four at the left side; and eight bending angles of eight teeth of one trench are selected from two kinds of different values and the teeth of different angles are alternatively arranged along one trench.
